(19) United States
(12) Patent Application Publication
(10) Pub. No.: US 2010/0252189 A1
(43) Pub. Date: Oct. 7, 2010

(54) Method and kit for decorating a pet's collar and/or leash or lead

(76) Inventor: Brian Fried, Melville, NY (US)

Correspondence Address: RICHARD B. KLAR, 145 WILLIS AVENUE, SUITE NO. 6, MINEOLA, NY, 11501, US

(21) Appl. No.: 12/798,068

(22) Filed: Mar. 29, 2010

Related U.S. Application Data
(60) Provisional application No. 61/211,589, filed on Apr. 1, 2009.

(51) Int. Cl. B32B 38/14; B43K 5/00; B41L 13/00

(52) U.S. Cl. 156/280; 401/292; 101/114

(57) ABSTRACT

A method and a kit for decorating a collar and a leash of a pet includes a collar and a leash or lead preferably made of a nylon material, a set of permanent, non toxic and odorless fabric markers of preferably five different colors, a stencil set of preferably images made preferably of paper stock having a sticky non-toxic backing to keep each image in place when applied to the pet's collar or leash (lead). The markers can be used to color each image while in the stencil set before removing a selected colored image to be placed on the pet's collar or leash for decorating the collar or leash.

### RELATED APPLICATIONS

This is a non provisional application of a provisional application Ser. No. 61/211,589 by Brian Fried dated Apr. 1, 2009.

### BACKGROUND

1. Field

The present invention relates to a method and a kit for decorating a pet's collar and/or a pet's leash or lead. In particular the present invention relates to a method and a kit for decorating a pet's collar that includes a stencil with a containing number or removable images including but not limited to various geometrically shaped patterned images that have non-toxic adhesive backings, a set of markers for coloring the images on the stencil, and a collar and a leash or lead. The present invention also can include in the kit gel paint, puff paint, magnified markers and washable glitter paint for use in decorating purposes.

2. The Related Art

U.S. Pat. No. 6,352,024 discloses a collar for a pet that includes decoration imitating a piece of clothing worn by a person.

U.S. Pat. No. 6,422,177 discloses a collar with a decorative apparatus.

U.S. Pat. No. 6,748,903 discloses a collar with a decorative fastener.

### SUMMARY

The present invention provides a method and a kit for decorating the collar and/or the leash (or lead) of a pet such as a dog. This provides a great arts and craft project for children and adults. The kit would provide a collar and a leash or lead preferably made of a cotton material, a set of markers preferably but not limited to permanent, non toxic and odorless fabric markers of preferably five different colors, a stencil set of any type but preferably but not limited to images made preferably of paper stock having a sticky non-toxic backing to keep each image in place when applied to the pet's collar or leash (lead). Alternatively the collar and leash can be made of a nylon material. The markers can be used to color each image while in the stencils et before removing a selected colored image to be placed on the pet's collar or leash for decorating the collar or leash. In this way the present invention provides method and a kit for decorating a pet's collar or leash. Alternatively, regular plastic stencils can be used for the present invention.

### BRIEF DESCRIPTION OF THE DRAWINGS

FIGS. 1-8 illustrate the method and kit in accordance with the present invention in which:

FIG. 1 shows a set of markers for use in accordance with the present invention;

FIG. 2 shows a pet's collar in accordance with the present invention;

FIG. 3 shows a pet's leash or lead in accordance with the present invention;

FIG. 4 shows a stencil set in accordance with the present invention;

FIG. 5 shows washable glitter paint in accordance with the present invention;

FIG. 6 shows puff paint in accordance with the present invention;

FIG. 7 shows metallic markers in accordance with the present invention; and

FIG. 8 shows gel paint in accordance with the present invention;

### DETAILED DESCRIPTION OF THE PREFERRED EMBODIMENT(S)

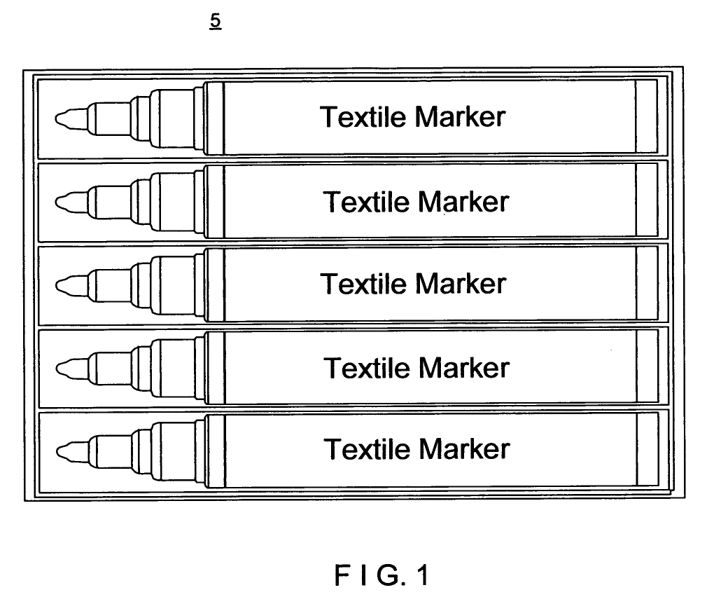

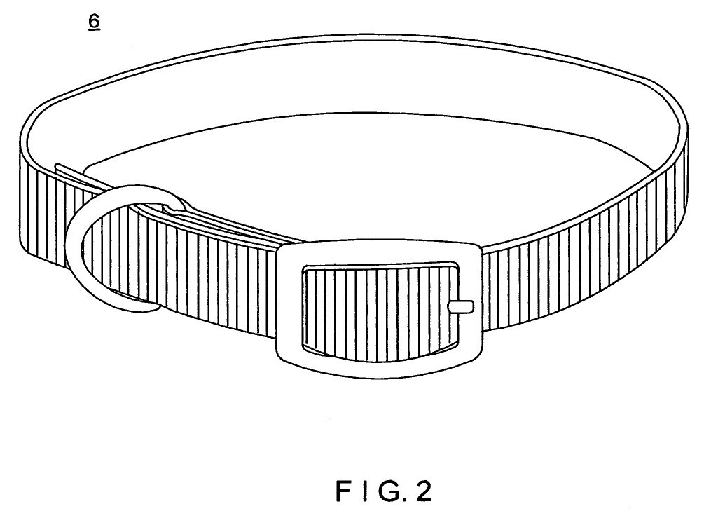

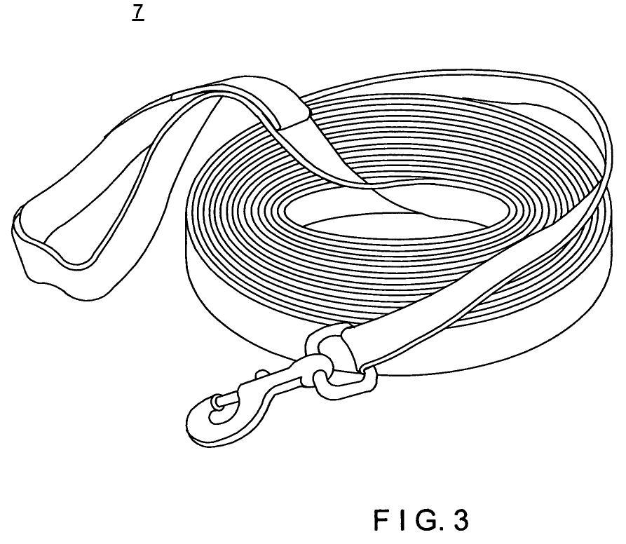

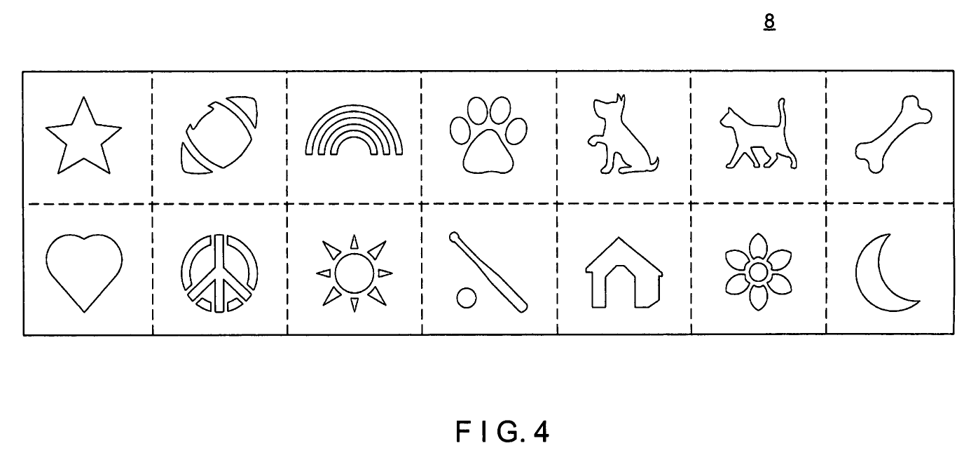

Referring now to the drawing, FIGS. 1-8 illustrate a method and a kit of the present invention. The present invention includes a kit formed of a set of markers 5 (FIG. 1), a collar 6 (FIG. 2) and a leash (or a lead) 7 (FIG. 3) that are provided and wherein the collar 6 and leash (lead) 7 incorporate preferably either cotton material or nylon canvas material throughout the collar 6 and the leash 7 including the handle but not the metal clip, the eyelets and the buckle pieces. The cotton material or the nylon material for the collar and leash can be made of any one of a variety of different colors. The set of markers can be but are not limited to permanent fabric markers 5 in the kit are preferably five markers of assorted colors. The markers 5 are preferably non-toxic and odorless although it is understood that any type of markers can be used. One non-limiting example of such markers 5 is the fabric markers sold by DriMark. The kit also includes a stencil set 8 (FIG. 4) that includes preferably 10-15 images that are removable from the stencil set and which can be adhesively applied to the collar 6 and leash 7. The images can preferably have a sticky, non-toxic backing for adhering to the collar and/or leash. The images can have different geometrical shapes such as star shaped 8a, heart shaped 8b, diamond shaped, 8c etc as shown in FIG. 4. It is understood that the invention is not limited to any particular design or geometric shapes of the stencil set of images 8 and the images shown are only presented as non-limiting illustrative examples. In addition the stencils do not have to be sticky stencils but can also include regular plastic shaped stencils. A user can color each images using the markers of the set 5 while the images are in the stencil set 8 before applying the thus colored images to the collar 6 or leash 7. In this way a user can decorate the collar 6 and the leash 7 for a pet such as a dog or a cat.

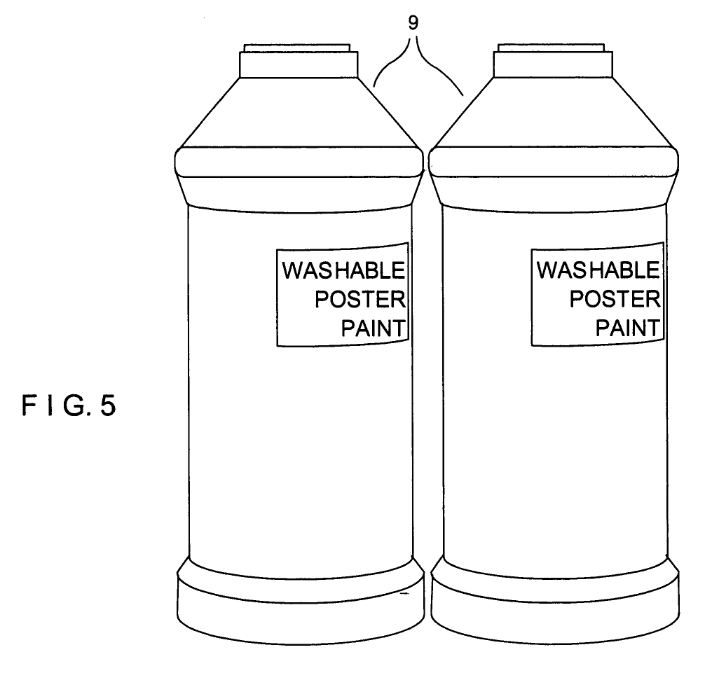

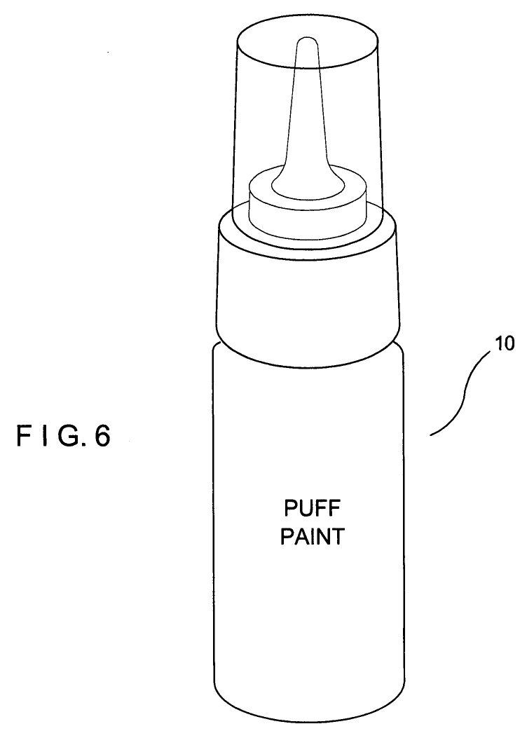

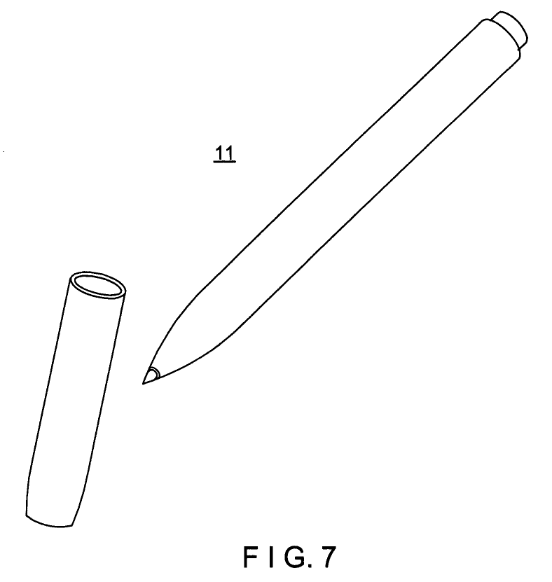

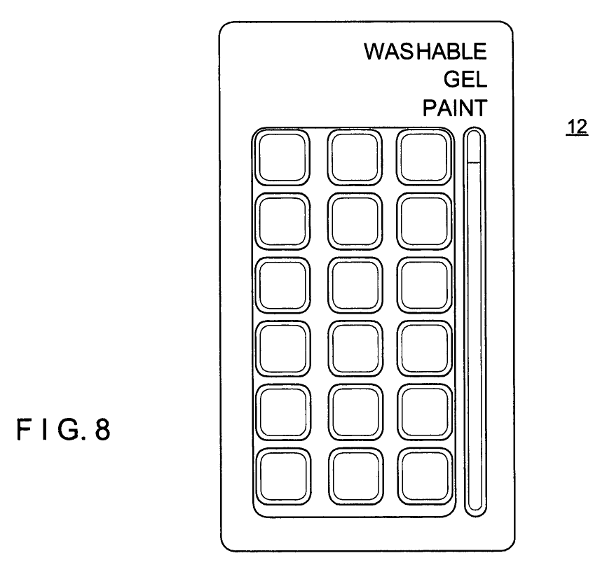

The kit can further include other decorative elements such as glitter paint 9 (FIG. 5), puff paint 10 (FIG. 6), metallic markers 10 (FIG. 7) and Gel Paint 11 (FIG. 8) for decorating the images on the stencil set and/or for decorating the collar and leash (lead). Non-limiting examples of these decorative elements in FIGS. 5-8 include Gel Paint 11 from Crayola, and metallic markers 10 from DriMark, puff paint 10 from So Soft and washable glitter paint 9 from Palmer.

The embodiments described above are not meant to be exclusive. Many other variations of the present invention would be obvious to those skilled in the art, and are contemplated to be within the scope of the appended claims.

1. A kit for decorating s pet's collar, comprising:
a collar and a leash for a pet;
a set of markers;
a stencil set including a plurality of images wherein one or more of said markers can color one or more of said images and said image scan be removed from said stencil set and adhesively applied to said collar or said leash to for decorative purposes.

2. The kit according to claim 1 wherein set of markers are permanent fabric markers.

3. The kit according to claim 1 wherein said collar and leash are made of either cotton or nylon material.

4. The kit according to claim 2 wherein said markers are non-toxic and odorless.

5. The kit according to claim 1 wherein said set of markers include five markers of assorted colors.

6. The kit according to claim 1 wherein said stencil set includes images formed of different geometric shapes.

7. The kit according to claim 5 wherein said shapes include a star shape.

8. The kit according to claim 1 wherein said stencil set includes approximately 10-15 images.

9. The kit according to claim 1 further comprising glitter paint (FIG. 5), for decorating the images on the stencil set and/or for decorating the collar and leash (lead).

10. The kit according to claim 1 further comprising puff paint for decorating the images on the stencil set and/or for decorating the collar and leash (lead).

11. The kit according to claim 1 further comprising metallic markers for decorating the images on the stencil set and/or for decorating the collar and leash (lead).

12. The kit according to claim 1 further comprising gel paint for decorating the images on the stencil set and/or for decorating the collar and leash (lead).

13. The kit according to claim 1 wherein said stencil set is formed of a paper stock and having a sticky non-toxic backing surface.

14. A method for decorating a pet's collar and/or leash, the steps comprising:
providing a collar and a leash;
providing a stencil set of images,
coloring one or more of said images in said stencil set with one or more markers; and
removing said images from said stencil set and adhesively applying said images to said collar or leash for decorative purposes.

15. The method according to claim 15 wherein each said image is formed of a paper stock and having a sticky non-toxic backing;

16. The method according to claim 14 wherein said one or more markers is from a set of permanent fabric markers.
